(19) United States
(12) Patent Application Publication
(10) Pub. No.: US 2012/0163628 A1
(43) Pub. Date: Jun. 28, 2012

(54) METHOD FOR REDUCING DIGITAL AUDIO OUTPUT NOISE

(75) Inventors: Kyung Hee Lee, Daejeon (KR); Chae Deok Lim, Daejeon (KR)

(73) Assignee: Electronics and Telecommunications Research Institute, Daejeon (KR)

(21) Appl. No.: 13/289,808

(22) Filed: Nov. 4, 2011

(30) Foreign Application Priority Data
Dec. 23, 2010 (KR) 10-2010-0134064

(51) Int. Cl. H04B 15/00

(52) U.S. Cl. 381/94.5

(57) ABSTRACT

An apparatus for reducing digital audio output noise includes: a signal processing unit configured to process digital audio data to output to a speaker; a switching unit configured to mute the speaker; and a control unit configured to monitor the signal processing unit to determine whether a current state is a mute state or not, and control the switching unit according to the determination result.

### CROSS-REFERENCES TO RELATED APPLICATIONS

The present application claims priority under 35 U.S.C 119(a) to Korean Application No. 10-2010-0134064, filed on Dec. 23, 2010, in the Korean intellectual property Office, which is incorporated herein by reference in its entirety set forth in full.

### BACKGROUND

Exemplary embodiments of the present invention relate to digital audio equipment, and more particularly, to a method for reducing digital audio output noise, which is capable of preventing a mute audio output caused by micro current when an analog signal of digital audio equipment is not provided.

The spread of various kinds of digital audio processing devices such as MP3 player, PMP, smart phone, digital set-top box has been expanded. A digital audio device keeps audio data stored therein or audio data received through a network in a buffer, and converts the audio data into an analog signal to output to a speaker.

In such a digital audio processing device, a speaker is a unit for generating a sound signal such that a person can hear a sound. The speaker receives an applied analog signal and vibrates a diaphragm to generate sound waves.

The above-described technical configuration is a related art for helping an understanding of the present invention, and does not indicate a prior art which is widely known in the technical field to which the present invention pertains.

In the conventional digital audio output device, an analog signal connected to the speaker may cause micro current to flow, even when there is no sound. Furthermore, even when no digital data is outputted, the analog signal may be amplified to generate a sound such as noise.

### SUMMARY

An embodiment of the present invention relates to an apparatus for reducing digital audio output noise, which monitors a buffer of a sound source and mutes a speaker, when determining that a current state is a mute state.

In one embodiment, an apparatus for reducing digital audio output noise includes: a signal processing unit configured to process digital audio data to be outputted to a speaker; a switching unit configured to mute the speaker; and a control unit configured to monitor the signal processing unit to determine whether a current state is a mute state or not, and to control the switching unit according to the determination result.

The switching unit may block an audio signal which is outputted from the signal processing unit and then inputted to the speaker.

The signal processing unit may include: an audio data storage section configured to store the digital audio data; and a digital/analog (D/A) conversion section configured to receive the digital audio data from the audio data storage section and to convert the received digital audio data into an analog signal.

The control unit may determine the mute state depending on whether or not the digital audio data is buffered in the audio data storage section.

The control unit may determine the mute state depending on whether the D/A conversion section is operating or not.

The apparatus may further include a volume control unit configured to control the volume of the speaker; and a volume value storage unit configured to store a volume value of the speaker.

The control unit may store the volume value of the speaker in the volume value storage unit, before the speaker is muted, and control the volume of the speaker to a minimum value through the volume control unit.

The control unit may control the volume of the speaker to the volume value stored in the volume value storage unit through the volume control unit, after canceling the mute state of the speaker.

### BRIEF DESCRIPTION OF THE DRAWINGS

The above and other aspects, features and other advantages will be more clearly understood from the following detailed description taken in conjunction with the accompanying drawings, in which:

FIG. 1 is a block configuration diagram of an apparatus for reducing digital audio output noise in accordance with an embodiment of the present invention; and

FIG. 2 is a flow chart showing the operation of the apparatus for reducing digital audio output noise in accordance with the embodiment of the present invention.

### DESCRIPTION OF SPECIFIC EMBODIMENTS

Hereinafter, an apparatus for reducing digital audio output noise in accordance with an embodiment of the present invention will be described with reference to accompanying drawings. The drawings are not necessarily to scale and in some instances, proportions may have been exaggerated in order to clearly illustrate features of the embodiments. Furthermore, terms to be described below have been defined by considering functions in embodiments of the present invention, and may be defined differently depending on a user or operator's intention or practice. Therefore, the definitions of such terms will be based on the descriptions of the entire present specification.

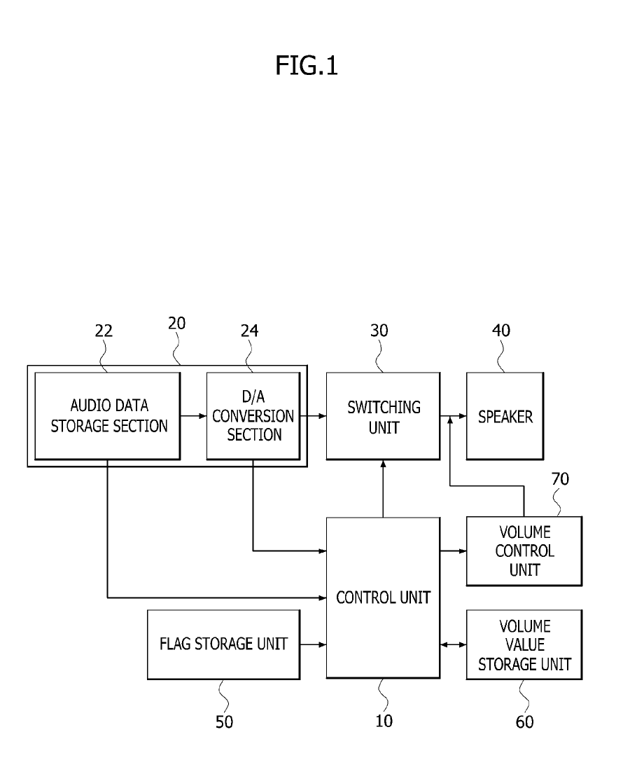

FIG. 1 is a block configuration diagram of an apparatus for reducing digital audio output noise in accordance with an embodiment of the present invention.

Referring to FIG. 1, the apparatus for reducing digital audio output noise in accordance with the embodiment of the present invention includes a signal processing unit 20, a switching unit 30, a speaker 40, a control unit 10, a flag storage unit 50, a volume value storage unit 60, and a volume control unit 70.

The signal processing unit 20 is configured to process digital audio data such that the speaker 40 may output the digital audio data. The signal processing unit 20 includes an audio data storage section 22 and a digital/analog (D/A) conversion section 24.

The audio data storage section 22 is a buffer for storing digital audio data. The audio data storage section 22 is configured to temporarily buffer digital audio data inputted from a sound source, and sequentially output the buffered digital audio data.

The D/A conversion section 24 is configured to convert digital audio data into an analog audio signal to output to the speaker 40.

The speaker 40 is configured to generate sound waves such that a person may hear the audio signal inputted from the D/A conversion section 24.

The flag storage unit 50 is configured to indicate whether the speaker 40 is in a mute state or not. In this case, a mute flag is initially set to 0. When the speaker 40 is muted, the mute flag is set to 0, and when the mute state is canceled, the mute flag is set to 1.

The volume value storage section 60 is a register for storing an audio output volume value immediately before the mute flag becomes 1.

The switching unit 30 for muting the speaker 40 is configured to input the audio signal received from the D/A conversion section 24 to the speaker 40 or block the audio signal.

The volume control unit 70 is configured to control the volume of the speaker 40.

The control unit 10 is configured to monitor the signal processing unit 20 to determine whether the current state is a mute state or not and control the switching unit 30 according to the determination result.

That is, the control unit 10 monitors the audio data storage section 22 to determine whether or not digital audio data is currently stored in the audio data storage section 22. Furthermore, the control unit 10 monitors the D/A conversion section 24 to determine whether the D/A conversion section 24 operates or not.

In this case, when digital audio data is not stored in the audio data storage section 22 or the D/A conversion section 24 does not operate, the control unit 10 controls the switching unit 30 to block the audio signal inputted to the speaker 40, thereby muting the speaker 40.

At this time, immediately before the speaker 40 is muted, the volume value of the speaker 40 is stored in the volume value storage unit 60. Furthermore, the control unit 10 controls the volume control unit 70 to control the volume value to a minimum value, and then mutes the speaker 40.

Then, when the mute state is canceled according to the result obtained by determining whether the current state is a mute state or not, the control unit 10 controls the switching unit 30 to input an audio signal to the speaker 40. Furthermore, the control unit 10 controls the volume control unit 70 to control the volume of the speaker 40 to the volume value stored in the volume value storage unit 60.

That is, before the speaker 40 is muted, the volume is controlled to the minimum value. Then, the mute state of the speaker 40 is canceled and the volume value is controlled to prevent an electric shock sound from occurring.

Hereinafter, the operation of the apparatus for reducing digital audio output noise in accordance with the embodiment of the present invention will be described.

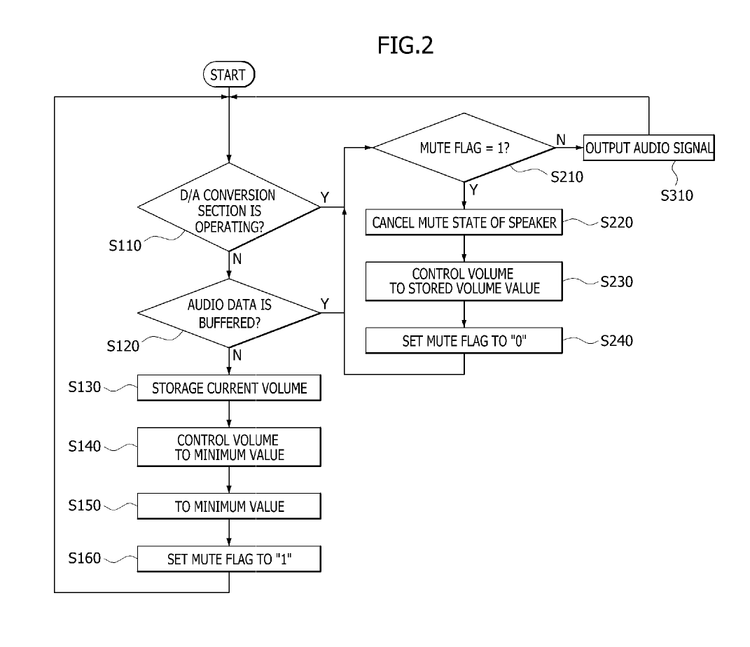

FIG. 2 is a flow chart showing the operation of the apparatus for reducing digital audio output noise in accordance with the embodiment of the present invention.

First, the control unit 10 determines whether the D/A conversion section 24 is operating or not, at step S110. Then, the control unit 10 determines whether or not digital audio data is buffered in the audio data storage section 22, at step S120.

As the determination result, when the D/A conversion section 24 is operating or digital audio data is buffered, the control unit 10 checks whether the mute flag is set 1 or not, at step S210.

In this case, when the mute flag of the flag storage unit 50 is set to 0, it indicates that the mute state of the speaker 40 is canceled and an audio signal is being outputted. Therefore, the audio signal is continuously outputted at step S310.

On the other hand, when the mute flag of the flag storage unit 50 is set to 1, it indicates that the speaker 40 is muted. Therefore, the control unit 10 controls the switching unit 30 to cancel the mute state of the speaker 40 at step S220.

When the mute state of the speaker 40 is canceled, the volume of the speaker 40 is controlled to a volume value stored in the volume storage unit 60 through the volume control unit 70, at step S230. Here, the volume value stored in the volume value storage unit 60 corresponds to a volume value set in the speaker 40 immediately before the speaker 40 is muted.

Therefore, when the mute state of the speaker 40 is canceled, the audio signal is outputted as the volume value before the mute state of the speaker 40 is canceled.

After the volume value is controlled, the mute flag is set to 0.

Meanwhile, according to the result obtained by monitoring the signal processing unit 20, when the D/A conversion section 24 does not operate and digital audio data is not stored in the audio data storage section 22, a current volume value is stored in the volume value storage unit 60 at step S130. Furthermore, the volume of the speaker 40 is controlled to a minimum value through the volume control unit 70, at step S140.

Then, the control unit 10 controls the switching unit 30 to mute the speaker 40 at step S140. At this time, since the speaker 40 is muted, the mute flag is set to 1.

In accordance with the embodiment of the present invention, it is possible to significantly reduce audio noise which may occur in a mute state where no digital audio data is provided due to packet delay during audio stream or in a mute section during voice communication through a mobile phone.

Furthermore, before and after the speaker is muted, the volume may be controlled to remove an electrical shock sound occurring when the speaker circuit is coupled.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. An apparatus for reducing digital audio output noise, comprising:
a signal processing unit configured to process digital audio data to be outputted to a speaker;
a switching unit configured to mute the speaker; and
a control unit configured to monitor the signal processing unit to determine whether a current state is a mute state or not, and to control the switching unit according to the determination result.

2. The apparatus of claim 1, wherein the switching unit blocks an audio signal which is outputted from the signal processing unit and then inputted to the speaker.

3. The apparatus of claim 1, wherein the signal processing unit comprises:
an audio data storage section configured to store the digital audio data; and
a digital/analog (D/A) conversion section configured to receive the digital audio data from the audio data storage section and to convert the received digital audio data into an analog signal.

4. The apparatus of claim 3, wherein the control unit determines the mute state depending on whether or not the digital audio data is buffered in the audio data storage section.

5. The apparatus of claim 3, wherein the control unit determines the mute state depending on whether the D/A conversion section is operating or not.

6. The apparatus of claim 1, further comprising:
a volume control unit configured to control the volume of the speaker; and
a volume value storage unit configured to store a volume value of the speaker.

7. The apparatus of claim 6, wherein the control unit stores the volume value of the speaker in the volume value storage unit before the speaker is muted, and controls the volume of the speaker to a minimum value through the volume control unit.

8. The apparatus of claim 6, wherein the control unit controls the volume of the speaker to the volume value stored in the volume value storage unit through the volume control unit, after canceling the mute state of the speaker.
